(19) United States
(12) Patent Application Publication
(10) Pub. No.: US 2025/0067369 A1
(43) Pub. Date: Feb. 27, 2025

(54) DROP-IN AND UNDER-DECK FIRESTOP DEVICES

(71) Applicant: RELIANCE WORLDWIDE CORPORATION, Atlanta, GA (US)

(72) Inventors: Virgil E. O'NEIL, Poway, CA (US); James Wittmer COSLEY, Poway, CA (US); Dennis L. HART, Poway, CA (US); Ryan Jeffrey MILLER, Poway, CA (US)

(21) Appl. No.: 18/723,906

(22) PCT Filed: Feb. 6, 2023
(86) PCT No.: PCT/US2023/062059

§ 371 Date: Jun. 25, 2024

Related U.S. Application Data
(60) Provisional application No. 63/309,972, filed on Feb. 14, 2022.

(51) Int. Cl. F16L 5/04

(52) U.S. Cl. CPC F16L 5/04

(57) ABSTRACT

Drop-in and under-deck firestop devices including a sleeve structure having an inner surface and an opposite outer surface. The firestop device includes a first smoke-seal ring positioned on the inner surface of the sleeve structure, a first intumescent ring positioned below the first smoke-seal ring on the inner surface of the sleeve structure, a second smoke-seal ring positioned on the outer surface of the sleeve structure; and a second intumescent ring positioned below the second smoke-seal ring on the outer surface of the sleeve structure. The first and second smoke-seal rings and the first and second intumescent rings are respectively adhered or otherwise secured to the inner and outer surfaces of the sleeve structure.

### CROSS REFERENCE TO RELATED APPLICATION

This patent application claims priority to U.S. Provisional Patent Application No. 63/309,972, filed Feb. 14, 2022, the disclosure of which is incorporated herein by reference in its entirety.

### TECHNICAL FIELD

The present disclosure relates generally to firestop devices commonly used in building structures; more particularly directed to drop-in and under-deck firestop devices for use with core drilled or pre-existing holes in concrete slabs during new construction or retrofitting and/or re-piping.

### BACKGROUND

Building regulations may require a listed firestop system be installed when rated assemblies within a building get penetrated or otherwise become compromised. These penetrations can take place through concrete structures, such as decks, slabs, walls, and floors. Items known as cast-in-place firestop devices involve the embedding of a tube and sealing materials in concrete as it is poured and hardens. Cast-in-place firestop sleeves can be used for newly poured concrete floors in multi-story buildings. However, cast-in-place firestop devices are not suitable when holes are needed to be firestopped in existing concrete floors, which are typically made by core-drilling, or when hollow sleeves are formed into the concrete floor slabs and thus lack built-in firestopping materials. Core-drilled holes can be made in cured concrete decks and firestopping may be performed at a later stage in construction. Core-drilling is often performed when a floor is built with corrugated metal decking and concrete, and the use of cast-in-place firestop devices is not always permitted. Cast-in-place firestop devices are also not suitable when an existing building is being retrofitted/re-piped and there are newly drilled and existing holes in the concrete deck that need to be firestopped.

There is a need for a more improved firestop device to provide the code required firestopping material through concrete structures and/or around pre-existing pipes, tubes, conduits, etc. already passing through a hole in the concrete structure that is easier to install. The present disclosure addresses these and other related and unrelated issues in the art.

### SUMMARY

The present disclosure relates to improved fire-stop devices. Specifically, the present disclosure relates to drop-in and under deck firestop devices that allow for firestopping of core-drilled, hollow sleeved, and existing holes in corrugated or flat concrete decks. Drop-in devices are designed for installation on a top side of a deck. Under-deck devices are designed for installation on a bottom side of a deck. Both drop-in and under deck devices according to the present disclosure include a cage or metal sleeve structure that can be opened and closed through a full 180-degree range of motion. As such, the drop-in and under deck devices can be opened and closed to collapse and lock around a tube, pipe, or conduit running through an existing hole or passage in a concrete deck.

One aspect of the present disclosure relates to a firestop device that includes a sleeve structure with a plurality of smoke-seal and intumescent location features. The sleeve structure can have an inner surface and an opposite outer surface. The firestop device can include a first smoke-seal ring positioned on the inner surface of the sleeve structure, a first intumescent ring positioned below the first smoke-seal ring on the inner surface of the sleeve structure, a second smoke-seal ring positioned on the outer surface of the sleeve structure; and a second intumescent ring positioned below the second smoke-seal ring on the outer surface of the sleeve structure. The first and second smoke-seal rings and the first and second intumescent rings can be respectively located on and adhered or otherwise secured to the inner and outer surfaces of the sleeve structure using the plurality of location features. The first intumescent ring can be attached to the inner surface of the sleeve structure by bending attachment tabs located on one end of the sleeve structure. The second intumescent ring and smoke-seal rings can be adhered to the inner and outer surfaces of the sleeve structure.

Another aspect of the present disclosure relates to a method of making a firestop device. The method includes a step of providing a sheet metal structure. The sheet metal structure can be movable between an unrolled/flat pattern configuration and a rolled configuration. The sheet metal structure can have an inner surface and an outer surface. The sheet metal structure can have a plurality of location features. When in the unrolled configuration, the method includes a step of securing a first smoke-seal ring and a first intumescent ring to the inner surface of the sheet metal and securing a second smoke-seal ring and a second intumescent ring to the outer surface of the sheet metal structure. The method includes a step of retaining the first and second smoke-seal rings and the first and second intumescent rings to the respective inner and outer surfaces of the sheet metal structure by locating the rings of the structure using the plurality of location features and securing them to the structure by adhesion or by bending attachment tabs.

A further aspect of the present disclosure relates to a method of installing a firestop device. The method includes a step of providing a sheet metal structure in an unrolled configuration. The sheet metal structure can have a first smoke-seal ring positioned on an inner surface thereof, a first intumescent ring positioned below the first smoke-seal ring on the inner surface, a second smoke-seal ring positioned on an outer surface of the metal cage, and a second intumescent ring positioned below the second smoke-seal ring on the outer surface. The method can include a step of moving the sheet metal structure from the unrolled configuration to a rolled/cylindrical configuration. The method can include a step of positioning the sheet metal structure into a cylindrical, or near cylindrical, passage formed or cut into the concrete. The method can also include a step of rigidly fixing the sheet metal structure in the rolled configuration into the concrete opening/void. In certain examples, the sheet metal structure is inserted from a top side of the concrete and rigidly fixed with support brackets. In other examples, the sheet metal structure is inserted from a bottom side of the concrete and rigidly fixed with wing plates.

These and other features and advantages will be apparent from a reading of the following detailed description and a review of the associated drawings. A variety of additional aspects will be set forth in the description that follows. The aspects can relate to individual features and to combinations of features. It is to be understood that both the foregoing general description and the following detailed description are exemplary and explanatory only and are not restrictive of the broad concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates an exploded perspective view of an example drop-in firestop device including a cage, support brackets, intumescent rings, and smoke-seal rings in accordance with principles of the present disclosure;

FIG. 2 illustrates an assembled front view of the drop-in firestop device of FIG. 1;

FIG. 3 illustrates a top view of the drop-in firestop device of FIG. 1 including a cover installed in a concrete structure by the brackets in accordance with the principles of the present disclosure;

FIG. 4 illustrates a cross-sectional view taken along line 4-4 of FIG. 3;

FIG. 5 illustrates a plan view of the cage of FIG. 1 in an unrolled/flat pattern, open configuration showing an inner side thereof;

FIG. 6 illustrates a plan view of the cage of FIG. 5 showing an outer side thereof;

FIG. 7 illustrates an enlarged view of a portion of FIG. 13 showing a latch arrangement on the cage;

FIG. 8 illustrates a cross-sectional view taken along line 8-8 of FIG. 2;

FIG. 9 illustrates a top view of the drop-in firestop device of FIG. 3 showing a pipe installed through the concrete structure in accordance with the principles of the present disclosure;

FIG. 10 illustrates a cross-sectional view taken along line 10-10 of FIG. 9;

FIG. 11 illustrates an enlarged view of a portion of FIG. 10;

FIG. 12 illustrates a top view of the cage of FIG. 2;

FIG. 13 illustrates a perspective view of FIG. 2;

FIG. 14 illustrates an enlarged view of a portion of FIG. 4;

FIGS. 15-16 illustrate enlarged views of portions of FIG. 13;

FIG. 17 illustrates a flow chart of an example method of making the drop-in firestop device of FIG. 1;

FIG. 18 illustrates a flow chart of an example method of installing the drop-in firestop device of FIG. 1;

FIG. 19 illustrates an exploded perspective view of an under-deck firestop device showing wing plates in accordance with the principles of the present disclosure;

FIG. 20 illustrates a top view of one of the wing plates of FIG. 19;

FIG. 21 illustrates a bottom view of the wing plate of FIG. 20;

FIG. 22 illustrates an assembled bottom perspective view of the under-deck fire stop device of FIG. 19;

FIGS. 23-24 illustrate enlarged views of portions of FIG. 22;

FIG. 25 illustrates a top view of the under-deck firestop device of FIG. 22;

FIG. 26 illustrates a side view of the under-deck firestop device of FIG. 22;

FIG. 27 illustrates a cross-sectional view taken along line 27-27 of FIG. 26;

FIG. 28 illustrates a bottom view of the under-deck firestop device mounted to a bottom concrete structure in accordance with the principles of the present disclosure;

FIG. 29 illustrates a cross-sectional view taken along line 29-29 of FIG. 28;

FIG. 30 illustrates an enlarged view of a portion of FIG. 29;

FIG. 31 illustrates a bottom view of the under-deck firestop device of FIG. 28 with a pipe installed through the opening in the concrete structure in accordance with the principles of the present disclosure;

FIG. 32 illustrates a cross-sectional view taken along line 32-32 of FIG. 31; and

FIG. 33 illustrates an enlarged view of a portion of FIG. 32.

### DETAILED DESCRIPTION

The present disclosure relates to improved drop-in and under-deck fire stop devices. The advantageous features of the drop-in and under-deck firestop devices allow for firestopping of core-drilled and existing holes in corrugated or flat concrete decks. The drop-in and under-deck firestop devices include a sleeve structure that can be opened and closed through a full 180-degree range of motion. When in an unrolled, open configuration, the sleeve structure can be assembled with smoke-seal and intumescent rings and shipped. The sleeve structure can be rolled to a closed, rolled/cylindrical configuration to collapse and lock around a pipe, tube, or conduit running through an existing hole or be placed within a passage of a concrete deck prior to installing the pipe.

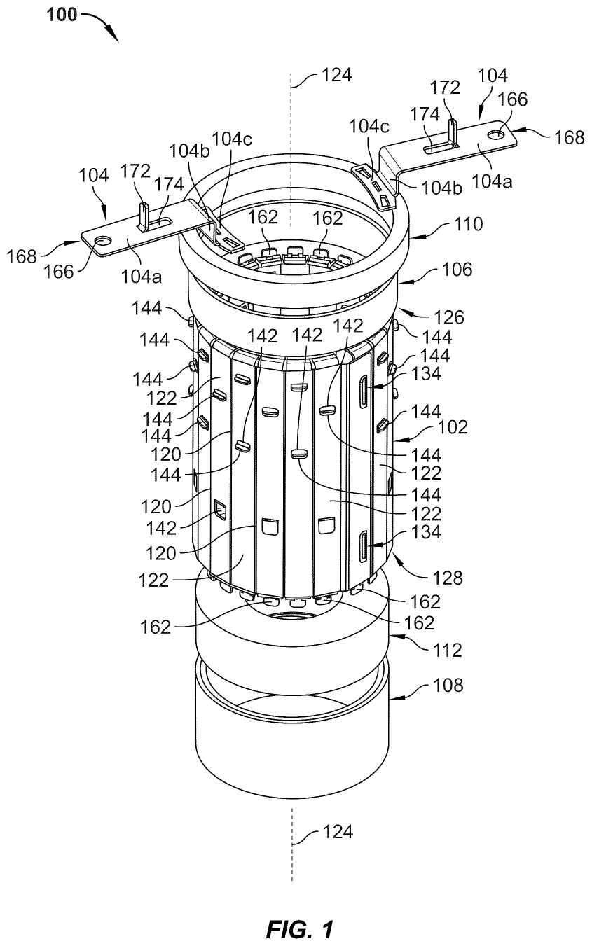

FIG. 1 illustrates an exploded view of an example drop-in firestop device 100 in accordance with principles of the present disclosure. The drop-in firestop device 100 includes a cage (e.g., sleeve structure) 102, support brackets 104, a first intumescent ring 106, a second intumescent ring 108, a first smoke-seal ring 110, and a second smoke-seal ring 112. The drop-in firestop device 100 is designed to meet fire rated standards per ASTM E814, ANSI/UL 1474, CAN ULC S115, or similar accepted industry fire rated standards.

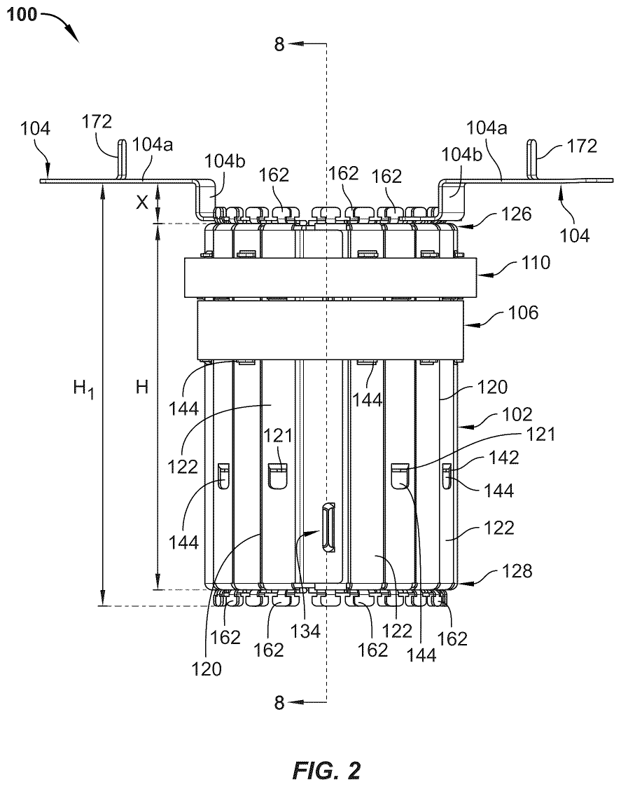

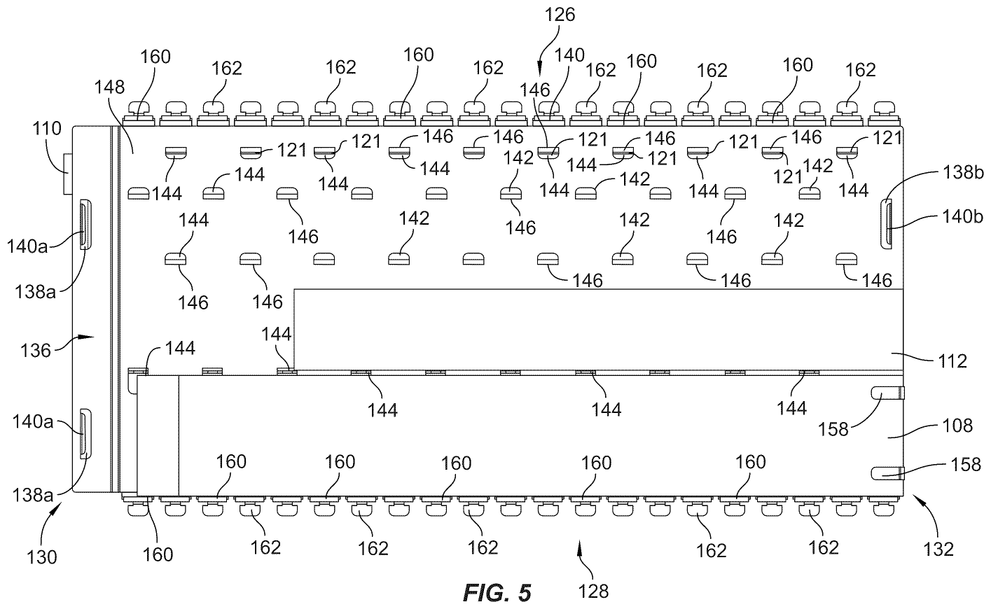

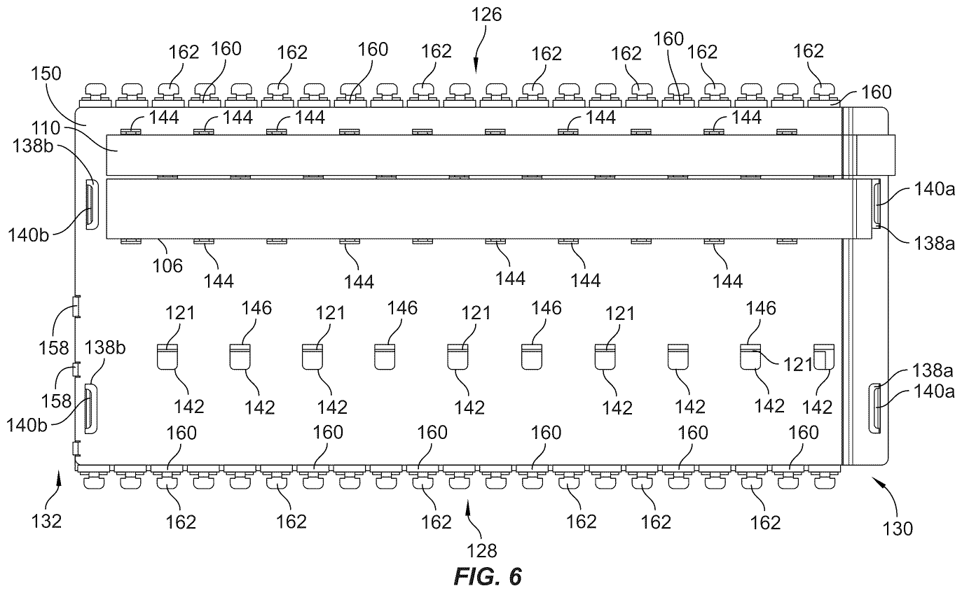

FIG. 2 shows the drop-in firestop device 100 assembled in a closed, rolled configuration. The cage 102 may be formed of a one-piece sheet metal construction by a stamping operation, although alternatives are possible. The sheet metal may include aluminum, corrosion resistant steel, galvanized metal or metal coated to resist corrosion. The cage 102 may initially be configured in an unrolled, open configuration (see FIGS. 5-6) for assembling the first and second intumescent rings 106, 108, and the first and second smoke-seal rings 110, 112 thereon prior to installation. While in the unrolled, open configuration, the cage 102 can be fully opened to a 180-degree position to provide full access to opposing side surfaces of the cage 102. The cage 102 is designed to be shipped in the unrolled, open configuration to allow for ease of handling in the field.

In certain examples, the cage 102 may be scored to form score lines (e.g., fold lines) 120 that create adjacent, parallel segments 122. In other examples, the segments 122 may be created by the punching process. The score lines 120 may function as a living hinge allowing the adjacent, parallel segments 122 of the cage 102 to bend along a length of the score lines 120 when rolled into the rolled, closed configuration. The adjacent segments 122 may be rectangular in shape and have a height H that extends along a longitudinal axis 124 of the drop-in firestop device 100 between a first side 126 (e.g., a top side, upper side) of the cage 102 and a second side 128 (e.g., a bottom side, lower side) of the cage 102.

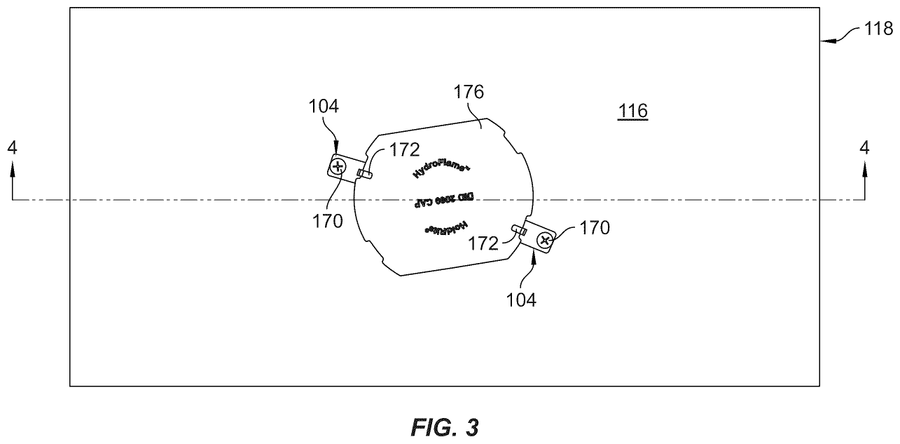

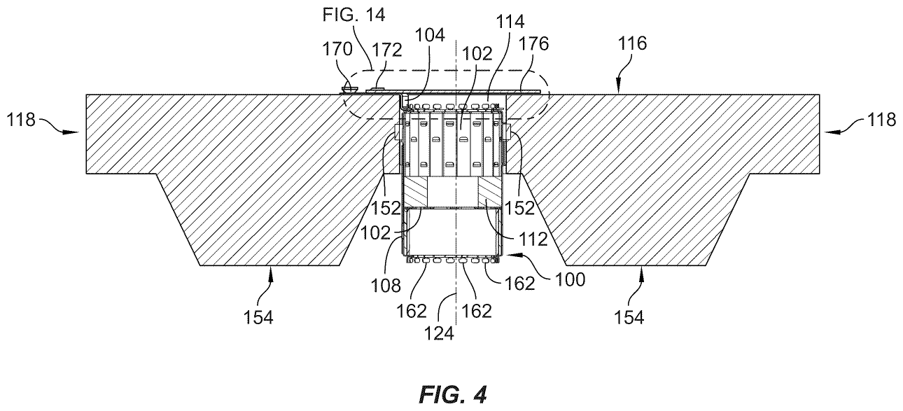

FIGS. 3-4 show the drop-in firestop device 100 installed in a preexisting, hollow sleeved, or core-drilled cylindrical passage or hole 114 through a concrete structure 118 in accordance with the principles of the present disclosure. The drop-in firestop device 100 may be inserted into the hole 114 from a top side 116 of the concrete structure 118. Typically, the hole 114 is bored or drilled after the concrete structure 118 has hardened, or is a pre-existing hole. The diameter of the hole 114 may vary with the diameter of the drill or boring tool.

The term “concrete structure” is used herein to generally refer to any various types of concrete structures, including, but not limited to, floors, decks, walls, slabs, inclined slabs, etc. The “cylindrical” passages or holes also include variations on the desired circular cross-section such as oval or multi-lobed cross-sections that are usually within an inch of a desired circular section.

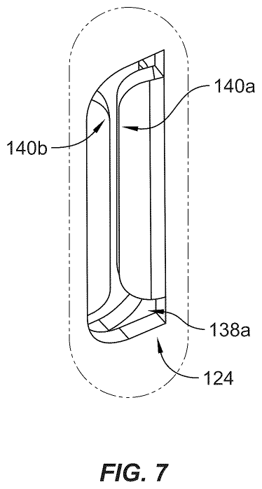

FIGS. 5-6 show the cage 102 in the unrolled, open configuration without the score lines 120 shown. The cage 102 has a first end 130 and an opposite, second end 132. When the sheet metal or cage 102 is rolled, that is, bent from its unrolled, open configuration into the rolled, cylindrical, closed configuration, the first and second ends 130, 132 of the cage 102 can be joined together. The first and second ends 130, 132 can be interconnected in a locking manner via a latch arrangement 134 (see FIG. 7). The latch arrangement 134 of the drop-in firestop device 100 can be used to secure the cage 102 in the rolled, closed configuration. For example, the cage 102 can be rolled into a 360-degree configuration. In certain examples, the cage 102 can be positioned to collapse around a tube, pipe, or conduit prior to the drop-in firestop device 100 being fitted from above into the hole 114. In certain examples, the cage 102 may also be placed inside the hole 114 prior to installation of a tube, pipe, or conduit. That is, once the drop-in firestop device 100 is ready to be installed, the cage 102 of the drop-in firestop device 100 may either be collapsed about a pipe and then pushed into the hole 114 of the concrete structure 118 or the cage 102 of the drop-in firestop device 100 may be pushed into the hole 114 of the concrete structure 118 before a tube, pipe, or conduit is installed.

The latch arrangement 134 can be located on an end segment 136 of the cage 102. The end segment 136 of the cage 102 can be positioned at the first end 130 of the cage 102. The first end 130 of the cage 102 can include at least one tab opening 138a (e.g., cutout, receptacle) through which a tab member 140a extends. The second end 132 of the cage 102 may also include at least one corresponding tab opening 138b (e.g., cutout, receptacle) with a tab member 140b. The tab openings 138a, 138b and the tab members 140a, 140b can be stamped or punched out of the sheet metal. As such, the tab members 140a, 140b can be defined by a region of sheet metal within a perimeter consisting of the tab openings 138a, 138b.

When the cage 102 is in the rolled, closed configuration, the first and second ends 130, 132 of the cage 102 are joined together. As such, that the at least one corresponding tab opening 138b and tab member 140b located at the second end 132 of the cage 102 can align with the at least one tab opening 138a and tab member 140a located at the first end 130 of the cage 102. The tab member 140a at the first end 130 of the cage 102 can be received and secured in the corresponding tab opening 138b at the second end 132 of the cage 102. The tab members 140a, b can make an interfering lock mechanism that creates the latch arrangement 134 to lock the cage 102 in the rolled, closed configuration about the longitudinal axis 124. The tab members 140a, 140b can be designed to lock within the tab openings 138 to hold the first and second ends 130, 132 of the cage 102 together in the rolled, closed configuration.

The drop-in firestop device 100 may be configured to fit a range of different diameters of tubes, pipes, or conduits with the penetrating pipe diameters typically differing by one quarter to two inches in diameter for passages from about 3 to about 8 inches in diameter, with larger ranges as the pipe diameter increases. For example, the cage 102 can have a diameter of about 4.5 inches. It will be appreciated that the cage 102 may be sized to fit a variety of different sized pipes. In certain examples, the cage 102 may be configured to fit a nominal pipe size of 2 inches, 2.5 inches, 3 inches, 4 inches or 6 inches. In certain examples, the cage 102 may also be sized to fit within a hole that has a diameter that ranges from about 3 inches to about 8 inches in a concrete structure.

Still referring to FIGS. 5-6, the end segment 136 of the cage 102 has two tab openings 138a that are positioned one above the other and each includes the tab member 140a, although alternatives are possible. The second end 132 of the cage 102 also includes two tab openings 138b positioned one above the other with tab members 140b, although alternatives are possible. Although the cage 102 is depicted with four total tab openings 138 with four tab members 140, in other examples (not shown) the cage 102 may include any other suitable number of tab openings and tab members. Also, although in the exemplary example the tab openings and tab members on each of the first and second ends 130, 132 are arranged in parallel with respect to each other along the longitudinal axis 124, in other examples some or all of the tab openings and tab members can be arranged asymmetrically or in any other suitable arrangement. It will be appreciated that other mechanical fasteners may be used to join the first and second ends 130, 132 of the cage 102 together.

Still referring to FIGS. 5-6, the cage 102 further defines a plurality of cutouts 142 or windows that can be stamped or punched through the metal sheet of the cage 102. When the metal sheet is punched, flaps or ring locating tabs 144 are created in the cage 102. The cutouts 142 each have an edge 146 that allow the flaps to extend outwardly therefrom toward either side of the cage 102. The ring locating tabs 144 of the cage 102 bend along a fold 121 in a generally L-shaped configuration for respectively retaining, securing, or locating the first and second intumescent rings 106, 108, and the first and second smoke-seal rings 110, 112 on the cage 102. For example, the ring locating tabs 144 can be stamped to bend along the fold 121 to extend outwardly from an inner surface 148 (see FIG. 5) of the cage 102 or outwardly from an outer surface 150 (see FIG. 6) of the cage 102.

The first and second intumescent rings 106, 108 and the first and second smoke-seal rings 110, 112 may be cut to length as desired prior to be being attached to the cage 102. While the cage 102 is in the unrolled or open position, the first intumescent ring 106 and the first smoke-seal ring 110 can be applied to the outer surface 150 thereof and the second intumescent ring 108 and the second smoke-seal ring 112 can be applied to the inner surface 148 thereof. The ring locating tabs 144 can be configured to help position and secure the first and second intumescent rings 106, 108 and the first and second smoke-seal rings 110, 112 onto the inner or outer surfaces 148, 150 of the cage 102, respectively.

It will be appreciated that the first and second intumescent rings 106, 108 and the first and second smoke-seal rings 110, 112 may each include split rings, respectively, with at least one split forming first and second adjacent ends.

In certain examples, the first and second intumescent rings 106, 108 and the first and second smoke-seal rings 110, 112 may each have adhesive backs that may be adhered to the inner and outer surfaces 148, 150 of the cage 102, respectively.

Turning to FIG. 8, the first smoke-seal ring 110 is shown on the outer surface 150 of the cage 102 adjacent the first side 126 thereof and above the first intumescent ring 106. When the cage 102 is rolled into the closed cylindrical configuration, the first smoke-seal ring 110 will also be circular in shape around the outside of the cage 102 and encircle the longitudinal axis 124 of the drop-in firestop device 100. Locking the cage 102 in the closed position allows the ends of the first smoke-seal ring 110 to approach each other in a tangential or circumferential direction such that there is believed to be little or no gap between the ends.

When the drop-in firestop device 100 is placed in the hole 114 of the concrete structure 118 as depicted in FIG. 4, the first smoke-seal ring 110 will be positioned between sidewalls 152 of the hole 114 and the cage 102 to seal against an inner diameter of the hole 114. In certain examples, the concrete structure 118 may be a concrete floor or concrete deck that has a corrugated bottom plate 154 on a lower side or bottom side thereof to act as a concrete form when the concrete is poured. The corrugated bottom plate 154 may also be referred to as a concrete pan or corrugated metal concrete form.

During use, the first smoke-seal ring 110 can help to prevent smoke/gas from passing through the periphery of the hole 114 in the concrete structure 118. A diameter of the cage 102 may be about ¼ an inch smaller than a diameter of the hole 114. The first smoke-seal ring 110 may be about ¼ inches thick to form an interference fit with the expected diameter or cylindrical shape of the hole 114 of the concrete structure 118. In one example, the first smoke-seal ring 110 may be configured to resiliently engage the hole 114 that has a diameter from about 3 inches to about 8 inches, although alternatives are possible.

The first smoke-seal ring 110 may be an adhesive-backed foam made of closed cell, thermoplastic urethane (TPU) or other suitable material. The TPU material is compressible and compresses flat into or against a pipe when the first intumescent ring 106 expands during a fire. The first smoke-seal ring 110 may function as a smoke stop to provide a barrier to smoke/gas moving along the longitudinal axis 124 of the drop-in firestop device 100. The first smoke-seal ring 110 may also function as a heat collector to trigger the first intumescent ring 106 activity by trapping any heat generated from a fire. As such, the first smoke-seal ring 110 can provide an initial barrier to smoke and heat at lower temperatures prior to reaching the higher temperatures needed to activate the first intumescent ring 106.

Still referring to FIG. 8, the first intumescent ring 106 is shown positioned about the outside of the cage 102 on the outer surface 150 thereof. The first intumescent ring 106 is positioned below the first smoke-seal ring 110 about ¼ inch, although alternatives are possible. The first intumescent ring 106 may be 2 mm thick and functions to expand when exposed to a fire to seal against an inner diameter of the hole 114. That is, when the temperature rises, the first intumescent ring 106 will heat up, expand, and char when exposed to flames. When the first intumescent ring 106 becomes hot enough, it will quickly expand to multiple times its original volume.

The first intumescent ring 106 may activate and begin to expand at approximately 375° F. to prevent the spread of flame/smoke/gases around the periphery of the hole 114 in the concrete structure 118. The first intumescent ring 106 may extend above the sidewall 152 and the cage 102 to expand both outward and upward along the longitudinal axis 124 to provide a seal against the hole 114 to prevent smoke and fire from passing upward through an annular gap between the cage 102 and the hole 114. This expansion will help to create a barrier, or seal, substantially preventing fire, heat, and smoke from moving from one area of a building to another for at least some period of time.

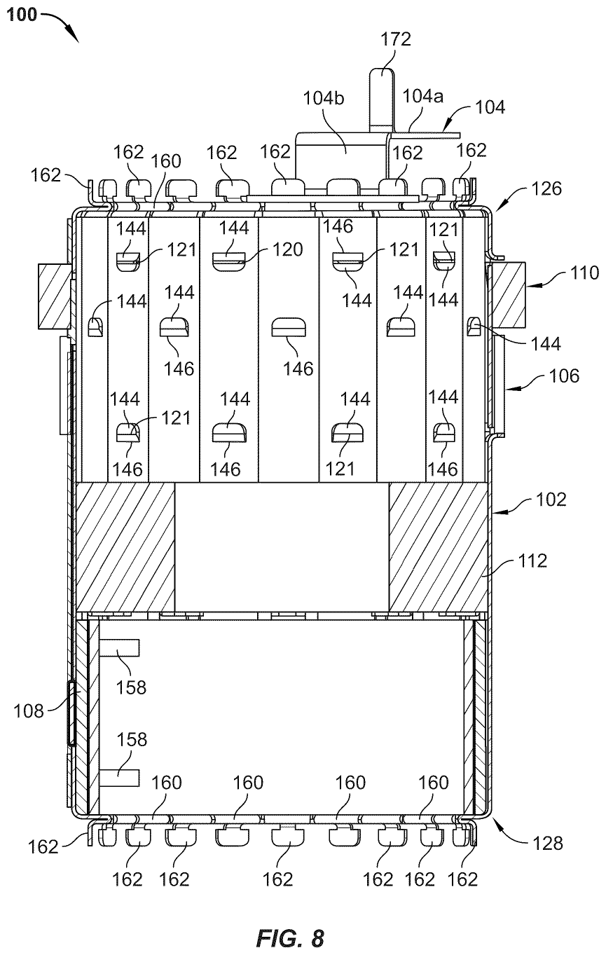

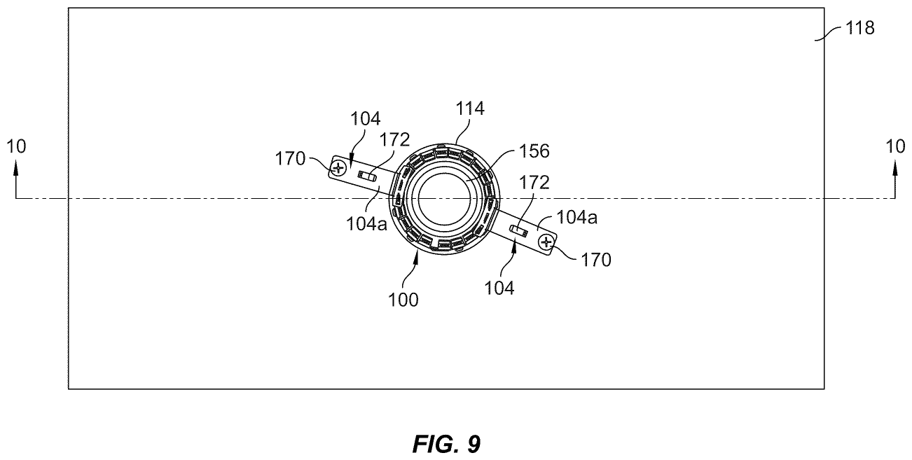

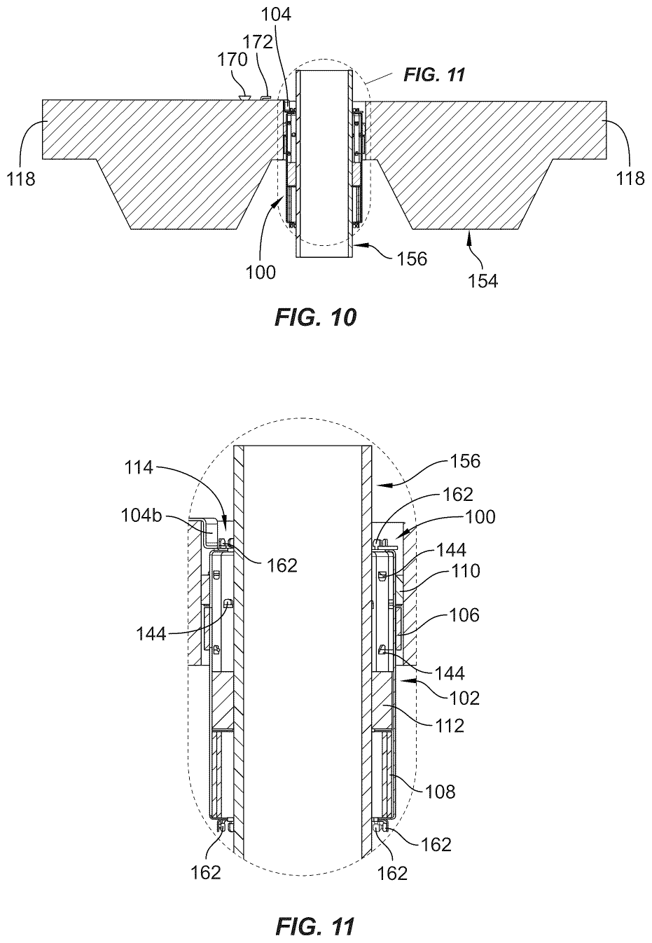

FIG. 8 also shows the second smoke-seal ring 112 and the second intumescent ring 108 placed on the inner surface 148 of the cage 102. Similar to the first smoke-seal ring 110, the second smoke-seal ring 112 is positioned above the second intumescent ring 108. The ring locating tabs 144 are positioned in the bent orientation to help position and secure the second smoke-seal ring 112 and second intumescent ring 108 on the cage 102. The second smoke-seal ring 112 is designed to seal against an outer diameter of a pipe 156 (e.g., tube, conduit, cable, wires, or other elongated members) placed within the hole 114 of the concrete structure 118 as shown in FIGS. 9-11. The pipe 156 may pass through the center opening of the second smoke-seal ring 112, the second intumescent ring 108, and the cage 102.

The second smoke-seal ring 112 prevents smoke/gas from exiting around the periphery of the pipe 156. The second smoke-seal ring 112 may be have an inner diameter sized to engage the outer portion or outer diameter of the pipe 156 passing through the hole 114 so as to provide a seal to prevent passage of smoke/gas. The pipe 156 may be a two-inch schedule 40 pipe, although alternatives are possible. In other examples, the second smoke-seal ring 112 may be about 1 inch thick suitable for pipes about 4-6 inches in diameter, although alternatives are possible.

The second intumescent ring 108 is positioned on the inner surface 148 of the cage 102 adjacent the second side 128 thereof. In addition to the ring locating tabs 144, to secure the second intumescent ring 108 to the cage 102, tabs or flanges 158 are also provided at one end of the cage 102 to position and secure the second intumescent ring 108. In certain examples, two separate lengths of the second intumescent ring 108 may be included. In other examples, up to 6 separate lengths of the second intumescent ring 108 may be used for use with six-inch firestop devices. The second intumescent ring 108 may be two millimeters thick, although alternatives are possible.

The second intumescent ring 108 activates and begins to expand at approximately 375° F. to prevent spread of flame/gas around the pipe 156 to seal against an outer diameter of the pipe 156. As the second intumescent ring 108 is heated and expands, the cage 102 helps to prevent the second intumescent ring 108 from expanding outward so the expansion of the second intumescent ring 108 is directed to expand inward and press against the pipe 156. The second intumescent ring 108 can include a select number of lengths to compress the pipe 156 and seal the entire hole 114 to prevent smoke/gas and fire from passing upward through the annular gap between the cage 102 and the hole 114.

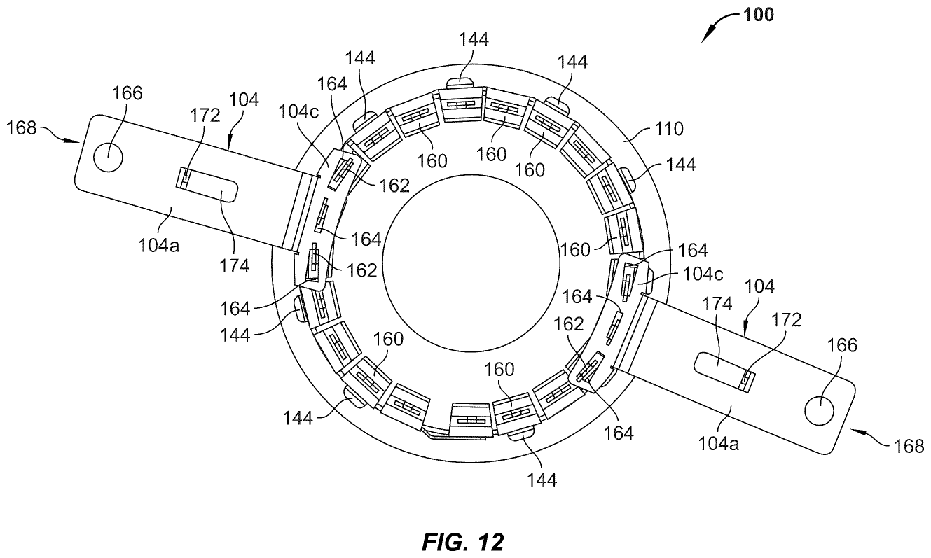

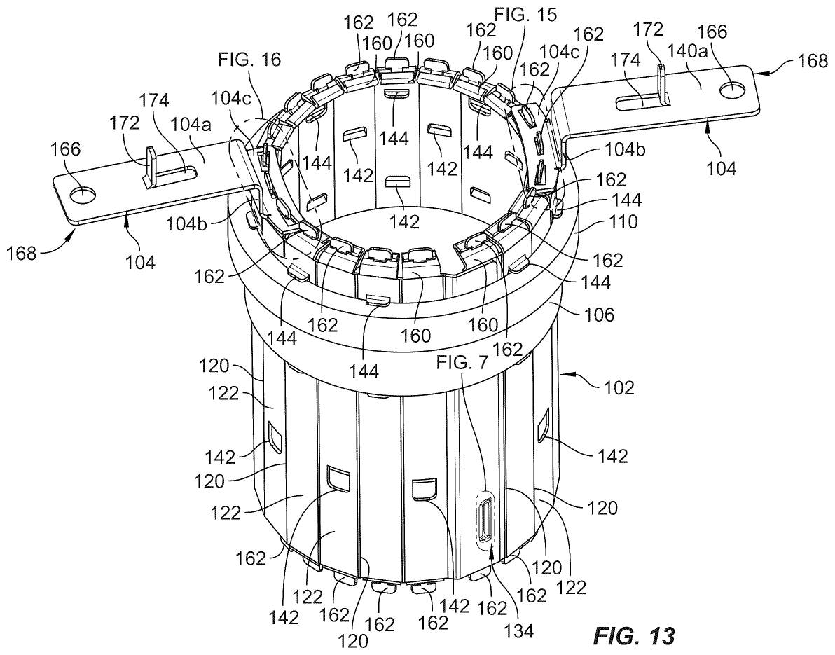

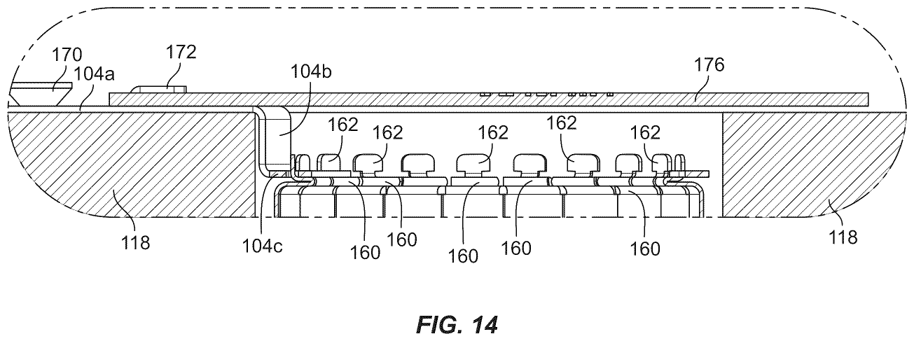

Turning to FIGS. 12-13, the support brackets 104 are shown mounted to the cage 102 at the first side 126 thereof. The support brackets 104 may be selectively positioned around the cage 102 via mounting tabs 160 to mount the drop-in firestop device 100 to a concrete structure 118 as shown in FIG. 14.

A plurality of the mounting tabs 160 are located at the first and second sides 126, 128 of the cage 102. The mounting tabs 160 are integrally formed with the segments 122 as shown in FIG. 8. The segments 122 create a bend around the first and second sides 126, 128 of the cage 102 to form the mounting tabs 160 with a projection 162 (e.g., tab portions). The score lines 120 can extend to the first and second sides 126, 128 to provide a living hinge for the mounting tabs 160 to allow the mounting tabs 160 to be rolled and unrolled with the cage 102. The projections 162 of the mounting tabs 160 extend in a direction away from respective first and second sides 126, 128 of the cage 102.

The support brackets 104 may have a stepped configuration. The support brackets 104 may each include a first extension member 104a and a second extension member 104c that are connected by a vertical step 104b. The first extension member 104a may be integrally connected at an upper portion of the vertical step 104b and the second extension member 104c may be integrally connected at a lower portion of the vertical step 104b. The first and second extension members 104a, 104c may be generally perpendicular relative to the vertical step 104b. The support brackets 104 may be made from sheet metal, for example, stainless steel, aluminum, or an alloy of these metals. In other examples, the support brackets 104 may be L-shaped.

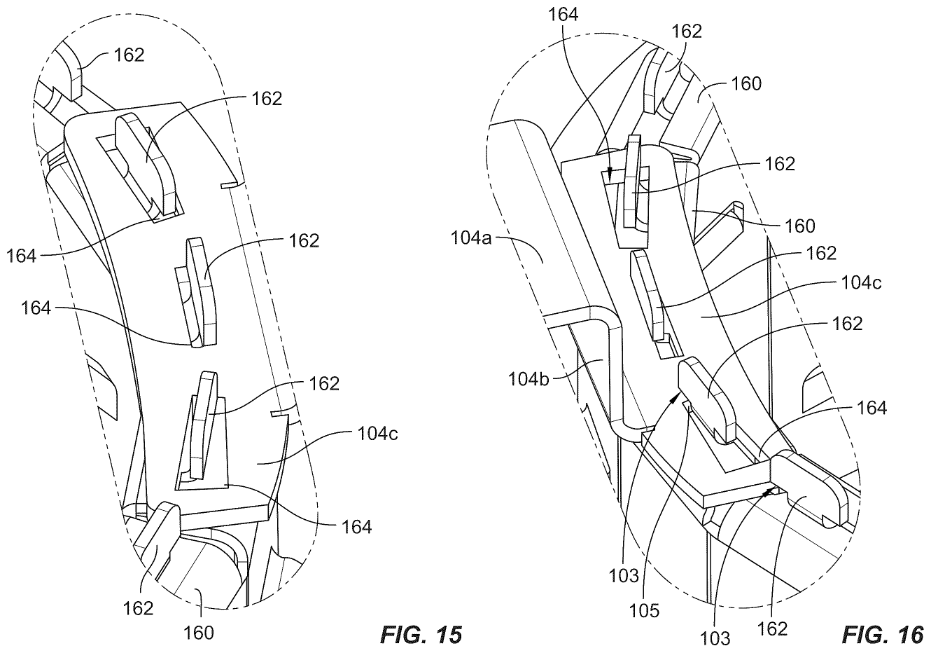

Referring to FIGS. 15-16, the second extension member 104c may define a plurality of projection openings 164 for receiving respective projections 162 of the plurality of mounting tabs 160 located at the first side 126 of the cage 102. The support brackets 104 can be selectively positioned about the cage 102 to receive respective ones of the projections 162 of the plurality of mounting tabs 160 as required to fit within dimensional constraints of a particular application.

In the example depicted, the second extension member 104c of the support brackets 104 each include three projection openings 164, although alternatives are possible. FIG. 15 shows the support bracket 104 in an unlocked position on the cage 102. FIG. 16 shows the support bracket 104 in a locked position on the cage 102 where a shoulder 103 of each respective projection 162 engages an edge 105 of the projection opening 164 in which it is positioned. Such a construction prevents inadvertent removal of the support bracket 104 from the cage 102.

Still referring to FIGS. 12-13, the first extension member 104a of the support brackets 104 each defines an opening 166 at a distal end 168 thereof. The opening 166 is configured to receive a concrete fastener 170 (see FIG. 14) for mounting the support brackets 104 at the top side 116 of the concrete structure 118 when the drop-in firestop device 100 is placed in the hole 114 of the concrete structure 118. In certain examples, the drop-in firestop device 100 may be placed in the hole 114 prior to the pipe 156 being installed. In other examples, the drop-in firestop device 100 may be wrapped about the pipe 156 prior to installation.

The first extension member 104a of the support brackets 104 may extend above the first side 126 of the cage 102 a distance X (see FIG. 2). In certain examples, the distance X is about 0.5 inches, although alternatives are possible. The total height H1 (see FIG. 2) of the drop-in firestop device 100 may be between about 5 inches to about 6 inches.

The first extension member 104a of the support bracket 104 may each include a tab member 172 stamped from a cutout 174 in the first extension member 104a. The tab members 172 can be used to secure a safety cap 176 (see FIG. 14) to the top side of the concrete structure 118. The safety cap 176 can be secured to the concrete structure 118 by bending the tabs 172 of the support brackets 104 down over the safety cap 176. The safety cap 176 can be designed to support loads as required by OSHA.

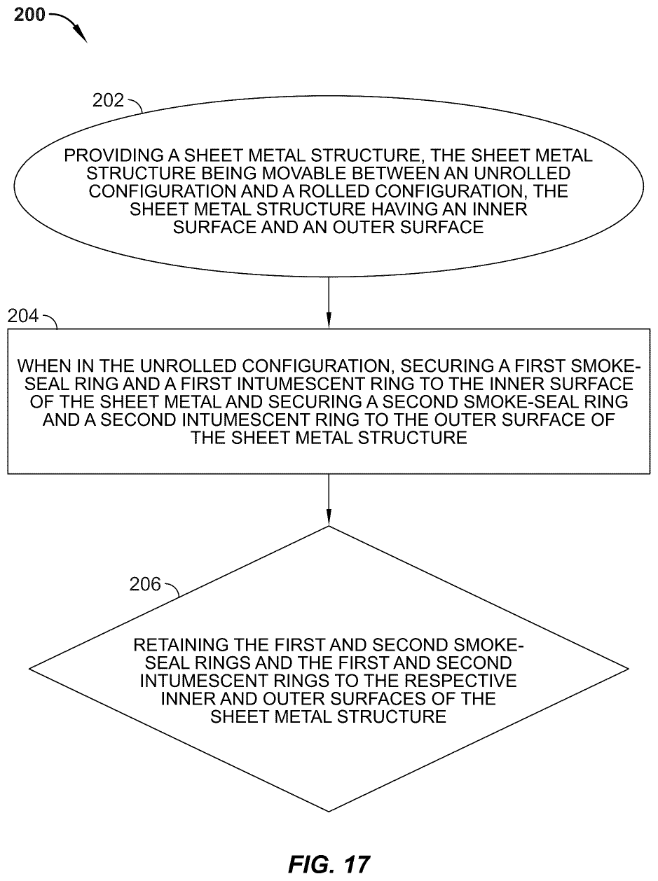

Another aspect of the present disclosure relates to a method of making a firestop device. The firestop device may be as described above. FIG. 17 is a flow chart illustrating an example method 200 of making the firestop device 100. In this example, the method 200 includes operations 202, 204, and 206.

The operation 202 is performed to provide a sheet metal structure of a desired size. The sheet metal structure can be movable between an unrolled/flat pattern configuration and a rolled/cylindrical configuration and the sheet metal structure can have an inner surface 148 and an outer surface 150. The sheet metal structure can have a plurality of ring locating tabs 144.

The operation 204 is performed when the sheet metal structure is in the unrolled configuration, securing a first smoke-seal ring 110 and a first intumescent ring 106 to the inner surface 148 of the sheet metal and securing a second smoke-seal ring 112 and a second intumescent ring 108 to the outer surface 150 of the sheet metal. It will be appreciated that the order of application of the first smoke-seal ring 110, the first intumescent ring 106, the second smoke-seal ring 112 and the second intumescent ring 108 is of no significance.

The operation 206 is performed to retain the first and second smoke rings 110, 112, and the first and second intumescent rings 106, 108, to the respective inner and outer surfaces 148, 150 of the sheet metal structure with the plurality of ring locating tabs 144.

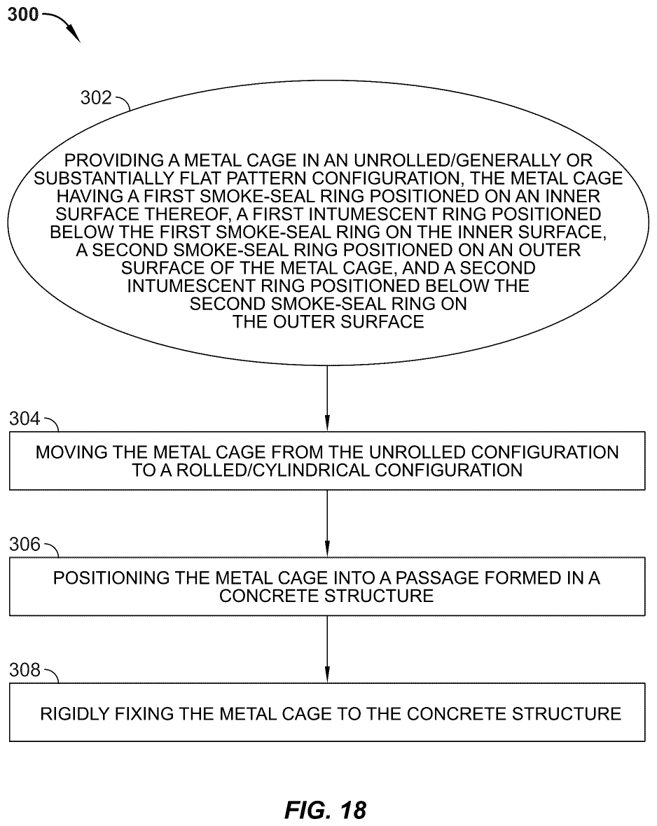

Another aspect of the present disclosure relates to a method of installing the firestop device 100 described above. FIG. 18 is a flow chart illustrating an example method 300 of installing the drop-in firestop device 100. In this example, the method 300 includes operations 302, 304, 306, and 308.

The operation 302 is performed to provide a metal cage 102 in an unrolled configuration. The metal cage can have a first smoke-seal ring 110 positioned on an inner surface 148 thereof, a first intumescent ring 106 positioned below the first smoke-seal ring 110 on the inner surface 148, a second smoke-seal ring 112 positioned on an outer surface 150 of the metal cage 102, and a second intumescent ring 108 positioned below the second smoke-seal ring 112 on the outer surface 150.

The operation 304 is performed to move the metal cage from the unrolled configuration to a rolled configuration.

The operation 306 is performed to position the metal cage 100 into a passage 114 formed in or drilled through a concrete structure.

The operation 308 is performed to rigidly fix the metal cage 102 to the concrete structure.

In certain examples, the metal cage 102 is inserted from a top side 116 of the concrete structure and rigidly fixed with support brackets 104. In other examples, the metal cage is inserted from a bottom side of the concrete structure and rigidly fixed with wing plates.

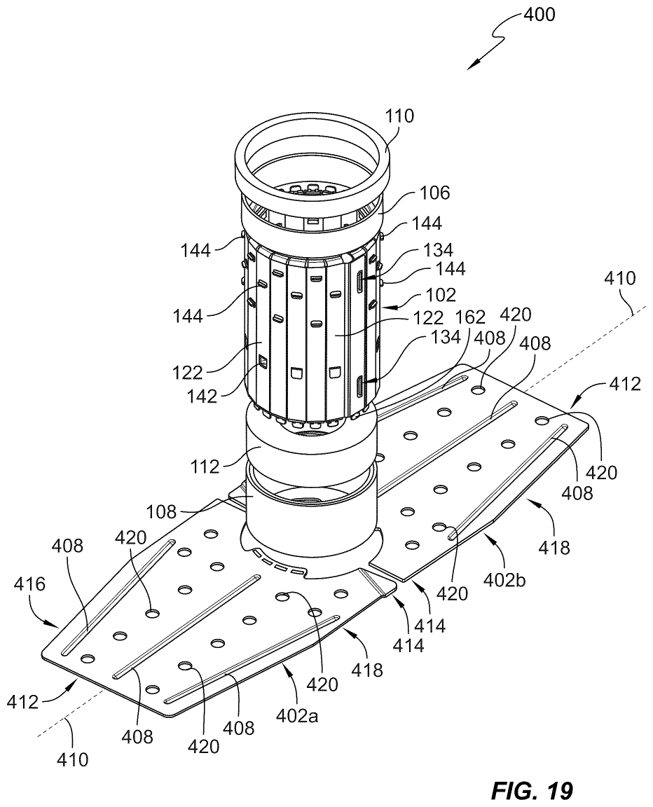

Turning to FIG. 19, an exploded perspective view of another firestop device is depicted in accordance with the principles of the present disclosure. The firestop device depicted is an under-deck firestop device 400 designed for installation from a bottom side of a concrete deck.

As shown, the under-deck firestop device 400 includes the cage 102 described above. For the sake of brevity, only those portions of the under-deck firestop device 400 that differ from the drop-in firestop device 100 illustrated in FIGS. 1-18 discussed above will be described in detail. Thus, similar components of the under-deck firestop device 400 that correspond to the respective components of the drop-in firestop device 100 will not be explained in detail again.

The under-deck firestop device 400 includes a set of identical first and second wing plates 402a, b configured to be mounted at the second side 128 of the cage 102. The first and second wing plates 402a, b may be stamped from sheet metal, for example, stainless steel, aluminum, or an alloy of these metals. The first and second wing plates 402a, b can be individually inserted and locked onto the cage 102 at the second side 128 thereof to form a circular opening thereabout, as will be described below.

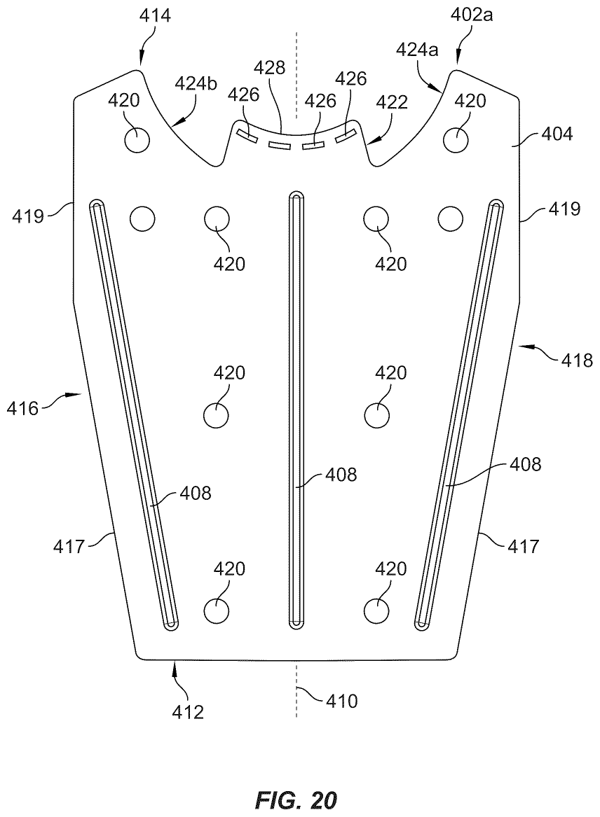

Referring to FIGS. 20-21, the first wing plate 402a is shown. Because the first and second wing plates 402a, b are identical, only the first wing plate 402a will be described in detail. It will be appreciated that the features described herein with reference to the first wing plate 402a will also apply to the second wing plate 402b.

The first wing plate 402a has a top surface 404 (see FIG. 20) and an opposite bottom surface 406 (see FIG. 21). In certain examples, the first wing plate 402a may be deformed to form a plurality of ribs 408 that may protrude from the top surface 404 thereby making a corresponding groove 408a on the bottom surface 406 of the first wing plate 402a. When the first wing plate 402a is mounted to the cage 102, the plurality of ribs 408 can be elongated along an axis 410 generally perpendicular to the longitudinal axis 124 of the cage 102. The plurality of ribs 408 can be stiffening ribs designed to strengthen the first wing plate 402a. In the example depicted, the first wing plate 402a includes three ribs 408, although alternatives are possible.

The first wing plate 402a has a distal end 412 and a proximal end 414. The proximal end 414 of the first wing plate 402a is designed to be mounted to the cage 102. The first wing plate 402a also has first and second opposing sides 416, 418 that extend between the first and second ends 412, 414.

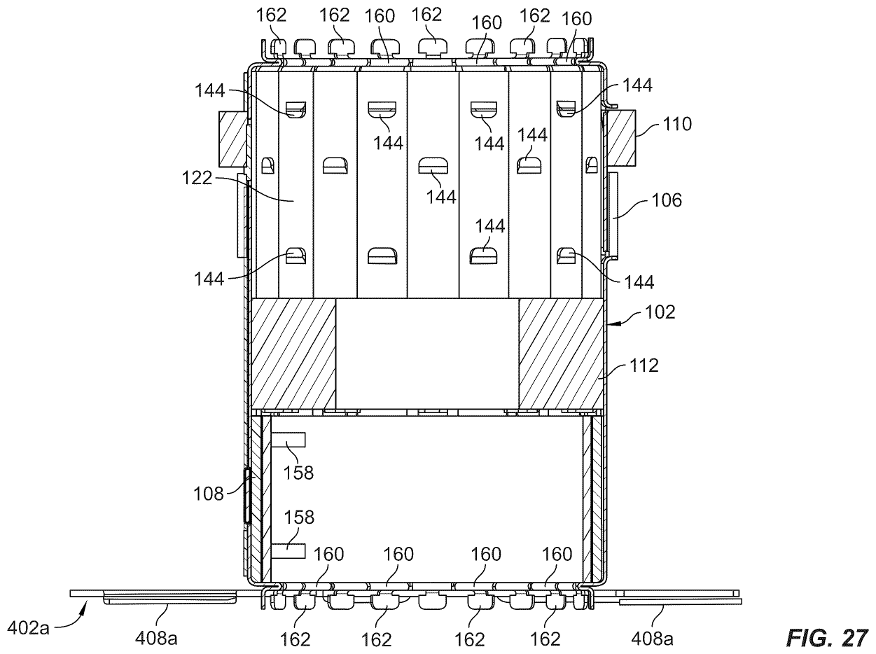

The first wing plate 402a can be mounted at the second side 128 of the cage 102 (see FIG. 27). In certain examples, the first wing plate 402a may be wider at the proximal end 414 and narrower at the distal end 412. That is, the first and second opposing sides 416, 418 can each have tapered portions 417 that taper outwardly from the distal end 412 toward straightened portions 419 at the proximal end 414.

The proximal end 414 of the first wing plate 402a also includes a projecting tab member 422 defined by recesses 424a, b on opposite sides thereof. The projecting tab member 422 defines locking holes 426 for receiving respective ones of the projections 162 of the plurality of mounting tabs 160 located at the second side 128 of the cage 102. That is, the first wing plate 402a can be selectively positioned about the cage 102 to receive any one of the projections 162 of the plurality of mounting tabs 160. In the example depicted, the projecting tab member 422 of the first wing plate 402a includes four locking holes 426, although alternatives are possible.

The projecting tab member 422 of the first wing plate 40a may include a concave edge 428 to interface circumferentially with an outer surface of a pipe, tube, or conduit 430 when installed. As noted above, the pipe 430 may be a 2 inch, 2.5 inch, 3 inch or 4 inch nominal pipe intended for installation in existing or core-drilled holes 114 from a bottom side 432 of a concrete deck 434. For example, the under-deck firestop device 400 may be collapsed around the pipe 430 prior to being placed in the hole 114 of the concrete deck 434 from the bottom side 323 thereof. In other examples, the under-deck firestop device 400 may be placed in the hole 114 without the pipe 430, which may be installed at a later date.

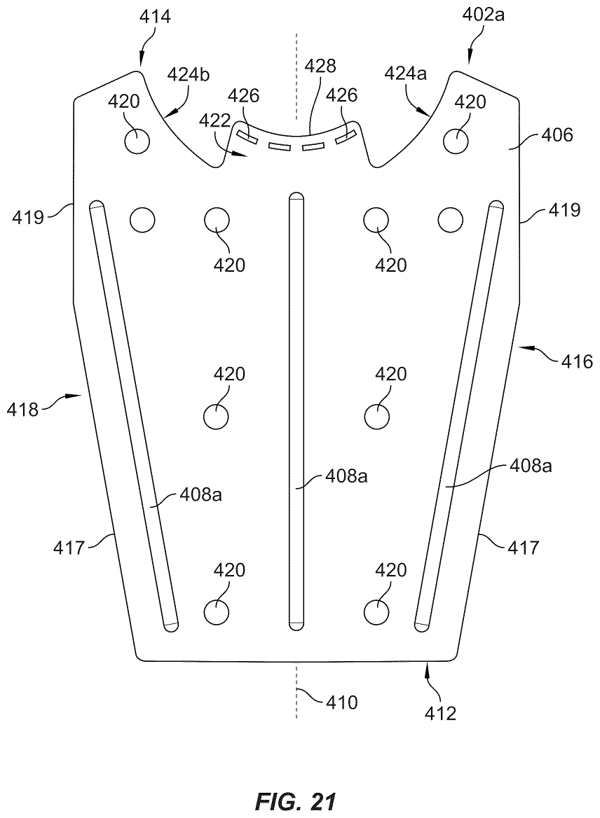

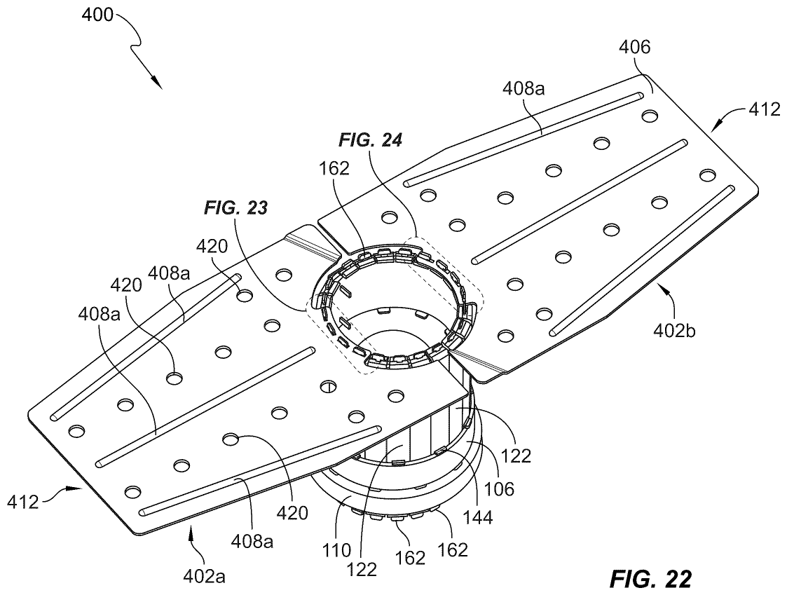

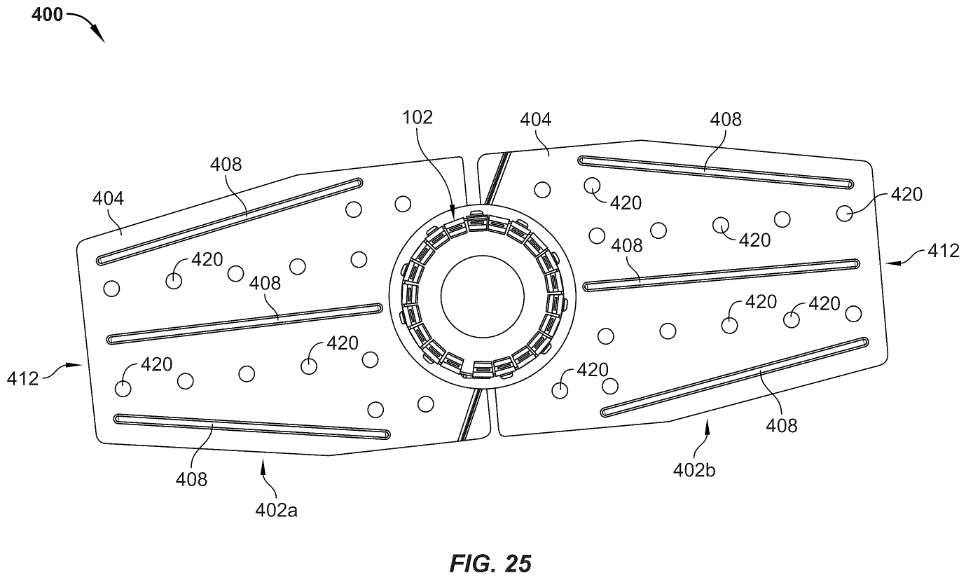

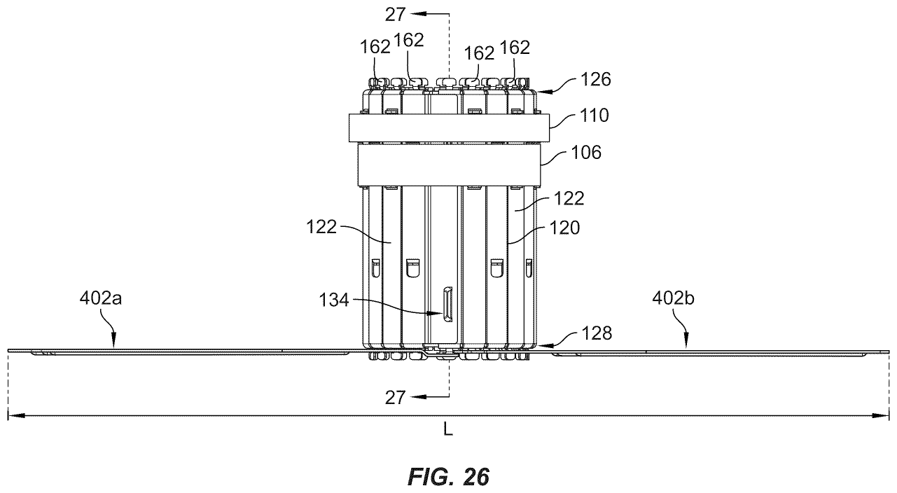

Referring to FIG. 22, a bottom perspective view of the under-deck firestop device 400 is depicted. The first wing plate 402a also defines a plurality of fastener holes 420 through which a shaft of a fastener passes when mounting the under-deck firestop device 400 to a concrete deck. FIGS. 25-26 show the first and second wing plates 402a, b, mounted at the second side 128 of the cage 102. The first and second wing plates 402a, b can each be independently mounted on the cage 102 when the cage 102 is in the rolled, closed configuration. Together the first and second wing plates 402a, b form a circular opening about the cage 102. The first and second wing plates 402a, b can be mounted opposite one another at any desired location around the cage 102 via the projecting tab member 422.

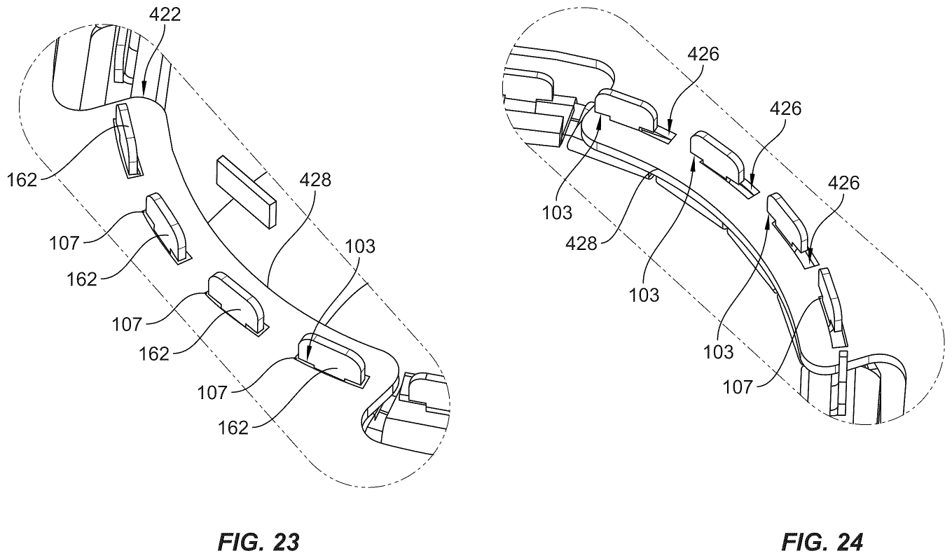

FIG. 23 depicts the first wing plate 402a mounted onto the cage 102 with the projections 162 of the mounting tabs 160 received within the openings 426 of the projecting tab member 422 of the first wing plate 402a. FIG. 23 shows the first wing plate 402a in an unlocked position on the cage 102 while FIG. 24 shows the first wing plate 402a in a locked position on the cage 102. In the locked position, the shoulder 103 of each respective projection 162 engages an edge 107 of the opening 426 in which it is positioned. Such a construction prevents inadvertent removal of the projecting tab member 422 of the first wing plate 402a from the cage 102.

FIG. 25 is a top view of the under-deck firestop device 400. The first and second wing plates 402a, b together can form a diameter about the cage 102 that ranges from about 4 inches to about 6 inches, although alternatives are possible. When the first and second wing plates 402a, b are mounted at the second end 128 of the cage 102, they measure a total length span L (see FIG. 26) from the distal ends 412 thereof. The length L can be from 10 to 20 inches, although alternatives are possible. In certain examples, the length L can be less than 20 inches. In certain examples, the length L is about 16 inches.

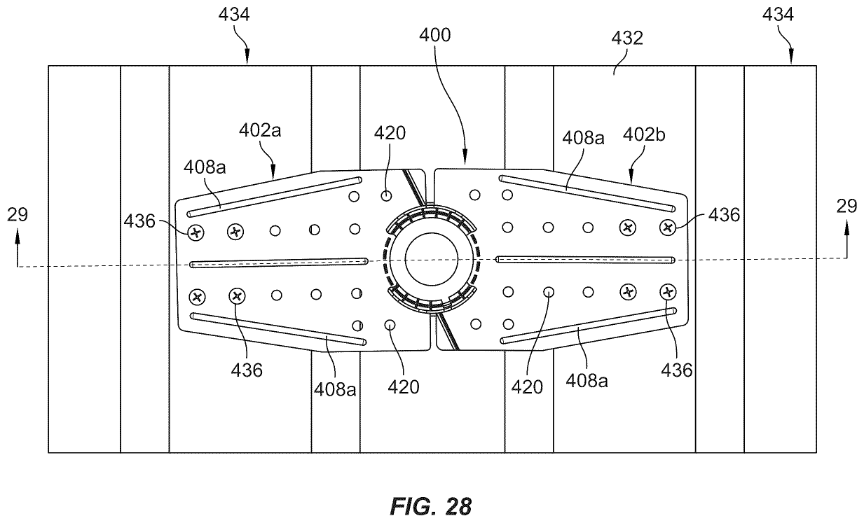

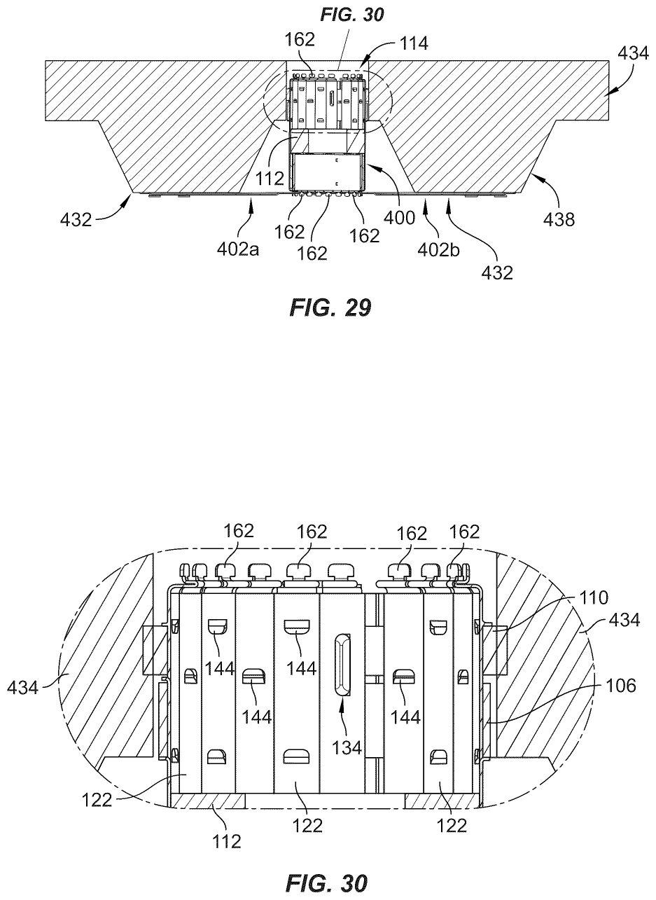

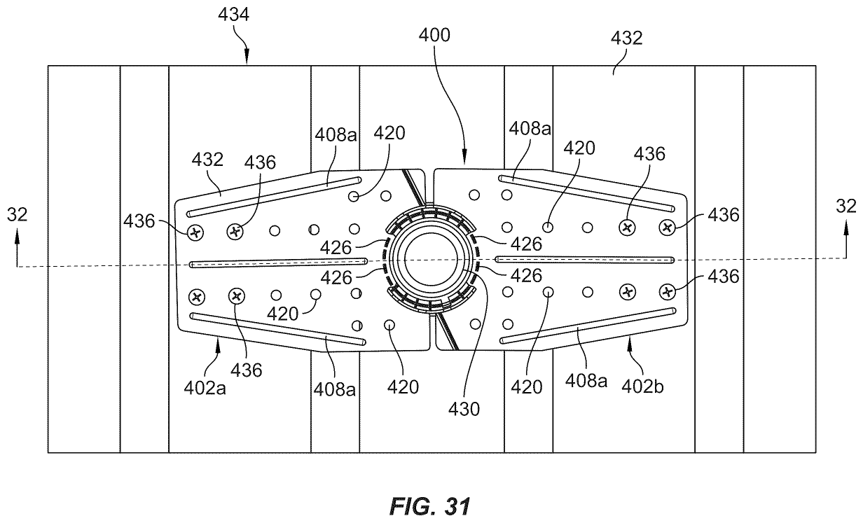

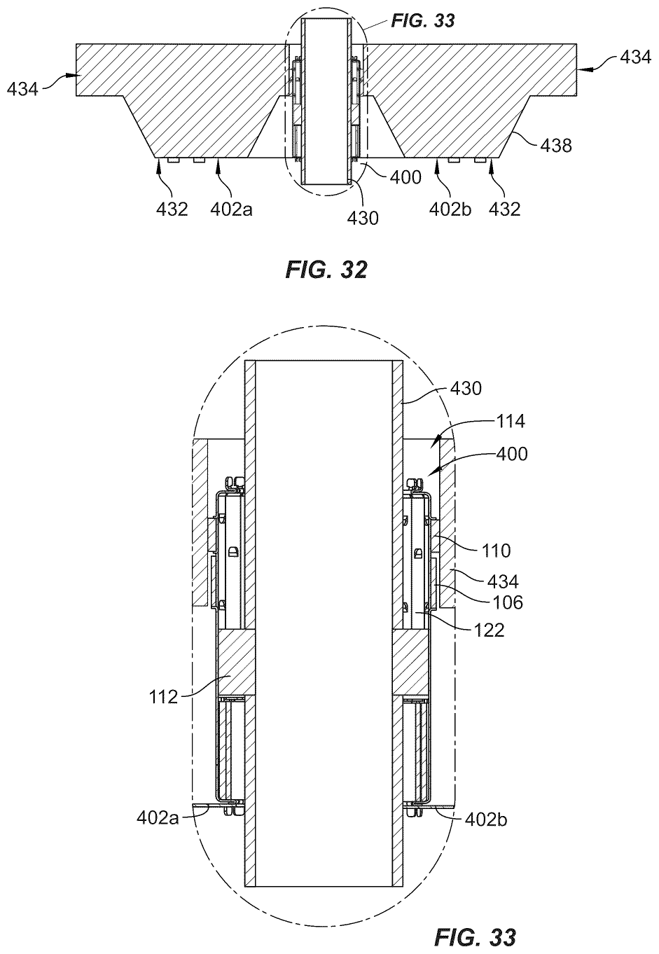

FIGS. 28-30 depict the under-deck firestop device 400 mounted to a concrete structure 434 and FIGS. 31-33 show the under-deck firestop device 400 with the pipe 430 installed.

The first and second wing plates 402a, 402b of the under-deck firestop device 400 can be secured to the bottom side 432 of the concrete deck 434 via concrete fasteners 436. That is, the concrete fasteners 436 may pass through the fastener holes 420 defined in the first and second wing plates 402a, 402b and into the concrete deck 434 to fasten the first and second wing plates 402a, 402b thereto.

In certain examples, the concrete fasteners 436 may also pass through a corrugated bottom plate 438 of the concrete deck 434 to fasten both the first and second wing plates 402a, 402b thereto. Accordingly, the fastener holes 420 and concrete fasteners 436 may align with the concrete for rigidly attaching the under-deck firestop device 400 thereto.

The principles, techniques, and features described herein can be applied in a variety of systems, and there is no requirement that all of the advantageous features identified be incorporated in a device, system or component to obtain some benefit according to the present disclosure.

From the forgoing detailed description, it will be evident that modifications and variations can be made without departing from the spirit and scope of the disclosure.

What is claimed is:

1. A firestop device comprising:
a sleeve structure having an inner surface and an opposite outer surface;
a first smoke-seal ring positioned on the inner surface of the sleeve structure;
a first intumescent ring positioned below the first smoke-seal ring on the inner surface of the sleeve structure;
a second smoke-seal ring positioned on the outer surface of the sleeve structure; and
a second intumescent ring positioned below the second smoke-seal ring on the outer surface of the sleeve structure.

2. The firestop device of claim 1, wherein, the sleeve structure is movable between an unrolled configuration and a rolled configuration, wherein, when in the rolled configuration, the sleeve structure has a first end, an opposite second end, and a longitudinal axis extending between the first and second ends.

3. The firestop device of claim 2, wherein the first and second ends of the sleeve structure include locating tabs with tab portions.

4. The firestop device of claim 3, further comprising support brackets configured to be selectively positioned at the first end of the sleeve structure via the mounting tabs to mount the firestop device to a top side of a concrete structure.

5. The firestop device of claim 4, wherein the concrete structure is a corrugated concrete deck.

6. The firestop device of claim 4, wherein the concrete structure is a flat concrete deck.

7. The firestop device of claim 3, further comprising wing plates configured to be selectively positioned at the second end of the sleeve structure via the mounting tabs to mount the firestop device to a bottom side of a concrete structure.

8. The firestop device of claim 1, further comprising a latch arrangement to lock the sleeve structure in the rolled configuration.

9. The firestop device of claim 8, wherein the latch arrangement includes a tab member and a tab opening for receiving the tab member.

10. The firestop device of claim 1, wherein the sleeve structure includes a plurality of ring locating tabs.

11. The firestop device of claim 10, wherein the first and second smoke-seal rings and the first and second intumescent rings are respectively adhered or otherwise secured to the inner and outer surfaces of the sleeve structure by the plurality of ring locating tabs.

12. The firestop device of claim 10, wherein the plurality of ring locating tabs are unitary with the sleeve structure.

13. The firestop device of claim 10, wherein the plurality of ring locating tabs are stamped into the sleeve structure.

14. The firestop device of claim 10, wherein the sleeve structure includes elongated segments each separated by score lines to allow the sleeve structure to be movable between the unrolled configuration and the rolled configuration.

15. The firestop device of claim 14, wherein the plurality of ring locating tabs are defined in the segments of the sleeve structure.

16. A method of making a firestop device, the method comprising:
providing a sheet metal structure, the sheet metal structure being movable between an unrolled configuration and a rolled configuration, the sheet metal structure having an inner surface and an outer surface;
when in the unrolled configuration, securing a first smoke-seal ring and a first intumescent ring to the inner surface of the sheet metal structure and securing a second smoke-seal ring and a second intumescent ring to the outer surface of the sheet metal structure; and
retaining the first and second smoke-seal rings and the first and second intumescent rings to the respective inner and outer surfaces of the sheet metal structure.

17. The method of claim 16, further comprising rolling the sheet metal structure to the rolled configuration.

18. The method of claim 16, further comprising locking the sheet metal structure in the rolled configuration using a latch arrangement.

19. The method of claim 18, wherein the latch arrangement is integrally formed with the sheet metal structure.

20. The method of claim 16, wherein the sheet metal structure has a plurality of ring locating tabs that are used to retain the first and second smoke-seal rings and the first and second intumescent rings to the respective inner and outer surfaces of the sheet metal structure.

21. A method of installing a firestop device, comprising:
providing a metal cage in an unrolled configuration, the metal cage having a first smoke-seal ring positioned on an inner surface thereof, a first intumescent ring positioned below the first smoke-seal ring on the inner surface, a second smoke-seal ring positioned on an outer surface of the metal cage, and a second intumescent ring positioned below the second smoke-seal ring on the outer surface;
moving the metal cage from the unrolled configuration to a rolled configuration;
positioning the metal cage into a passage formed or drilled into a concrete structure; and
rigidly fixing the metal cage to the concrete structure.

22. The method of claim 21, wherein the metal cage is inserted from a top side of the concrete structure and rigidly fixed with support brackets.

23. The method of claim 21, wherein the metal cage is inserted from a bottom side of the concrete structure and rigidly fixed with wing plates.
